(19) United States
(12) Patent Application Publication
(10) Pub. No.: US 2011/0298418 A1
(43) Pub. Date: Dec. 8, 2011

(54) Electronic book with wireless charging feature

(75) Inventor: Ming-Hsiang Yeh, Taipei City (TW)

(73) Assignee: Winharbor Technology Co., Ltd.,, New Taipei City (TW)

(21) Appl. No.: 13/067,427

(22) Filed: Jun. 1, 2011

(30) Foreign Application Priority Data
Jun. 8, 2010 (TW) 099210889

(51) Int. Cl. H02J 7/00

(52) U.S. Cl. 320/108

(57) ABSTRACT

An electronic book with wireless charging feature is disclosed. The electronic book includes a main body that forms a receptacle in which a carrier board is received. The carrier board is coupled to the main body and the carrier board includes a transmitter circuit. The transmitter circuit transmits an AC signal in a wireless manner to an electronic device that is provided with a receiver circuit to electrically charge a rechargeable battery of the receiver circuit. As such, electrical power can be stored and subsequently supplied to the electronic device, whereby the problem of limited range of using an electrical charger that requires wired connection can be overcome.

### FIELD OF THE INVENTION

The present invention relates to an electrical charging device, and in particular to application of the electrical charging device to an electronic book or the likes.

### BACKGROUND OF THE INVENTION

With the continuous progress of technology and science, the demand for electronic devices by general consumers is increasingly upgraded, especially for consumer electronic products. Electronic devices, which were bulky in size, such as optic disk players, household telephones, and desk-top computers, are being changed to compact and portable electronic products of high performance, such as multimedia player (for example MPEG Audio Layer-3, MP3), mobile phones, and notebook computers, all leading to a more efficient life for human beings.

Most of such portable electronic products, including the multimedia players and mobile phones, are powered by rechargeable batteries or cells, such as nickel hydride battery and lithium battery. The rechargeable battery is re-chargeable through a charging device or charger, which is composed of a charging seat and an electrical connector. The charging seat forms a charging chamber in which the rechargeable battery is positioned, while the electrical connector is set in connection with a power socket, such as a wall outlet to supply a required voltage or current to charge the rechargeable battery. On the other hand, the electronic device, such as notebook computer, is provided with an adaptor that is electrically connectable with the wall outlet, whereby the adaptor that receives electrical power from the wall outlet supplies a required voltage or current to the notebook computer. Since the portable electronic products must be powered through the adaptor or by a rechargeable battery, those who attempt to carry these products outdoors must also carry various adaptors or chargers. This is very inconvenient for the users of the products and makes the use inconvenient. Further, the charging device or the adaptor must use connection wires to transmit electrical power for charging the rechargeable battery. This limits the range where the charging device or the adaptor is useful.

In view of such problems, the present invention aims to provide an electronic book with wireless charging feature that allows of electrical charging operation to be performed in a wireless manner so as to overcome the problem of limited range of use.

### SUMMARY OF THE INVENTION

An objective of the present invention is to provide an electronic book with wireless charging feature, which allows of performance of electrical charging for various electronic devices without using and connection with additional electrical chargers.

Another objective of the present invention is to provide an electronic book with wireless charging feature, which overcomes the problem of limited range of use by applying wireless charging.

To achieve the above objectives, the present invention provides an electronic book with wireless charging feature. The electronic book is structured to couple with an electronic device comprising a receiver circuit. The electronic book comprises: a main body, which comprises a power member and forms a receptacle; a carrier board, which is coupled to the main body and is receivable in the receptacle, the carrier board being arranged to selectively receive the electronic device positioned thereon; and at least one transmitter circuit, which is provided in the carrier board and receives electrical power from the power member, the transmitter circuit converting the electrical power into an AC signal, which is transmitted by the transmitter circuit to the receiver circuit of the electronic device in a wireless manner to allow the receiver circuit to convert the AC signal into electrical power for performing electrical charging operation. As such, electrical charging to various electronic devices, can be realized without applying any additional electrical charger. Further, the problem of limited range of using an electrical charger that requires wired connection can thus be overcome. The convenience of use is improved.

### BRIEF DESCRIPTION OF THE DRAWINGS

The present invention will be apparent to those skilled in the art by reading the following description of preferred embodiments thereof with reference to the drawings, in which:

FIGS. 1A-1E are perspective views illustrating various conditions of an electronic book with wireless charging feature according to a first embodiment of the present invention;

FIG. 1F is a perspective view illustrating use of the electronic book according to the first embodiment of the present invention;

FIGS. 1G-1J are circuit diagrams of the electronic book according to the first embodiment of the present invention; and

FIGS. 2A-2C are perspective views showing various conditions of an electronic book with wireless charging feature according to a second embodiment of the present invention.

### DETAILED DESCRIPTION OF THE PREFERRED EMBODIMENTS

### First Embodiment

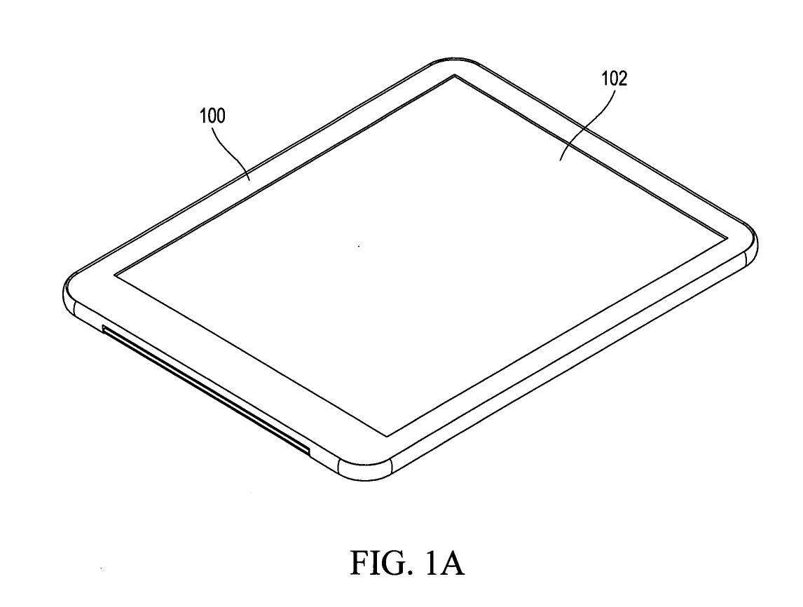

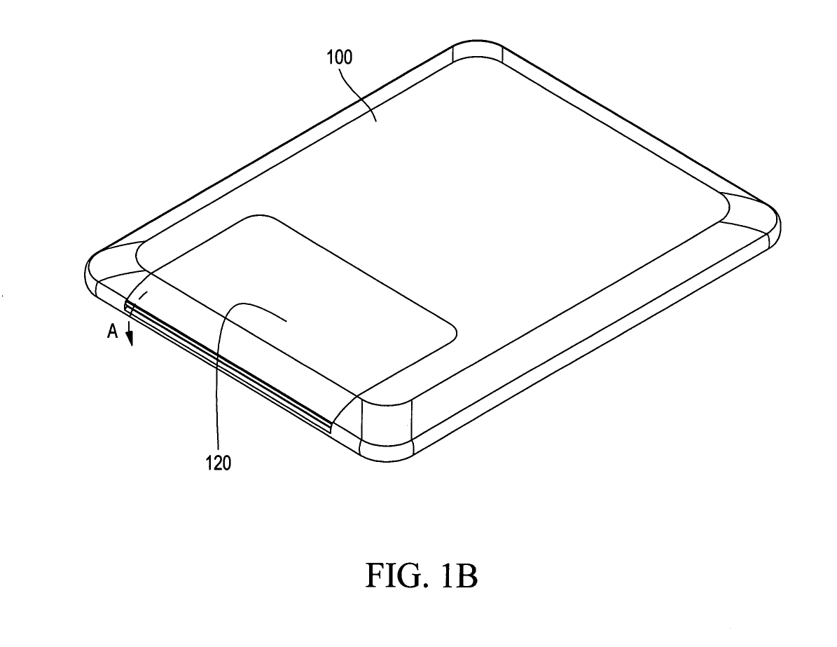

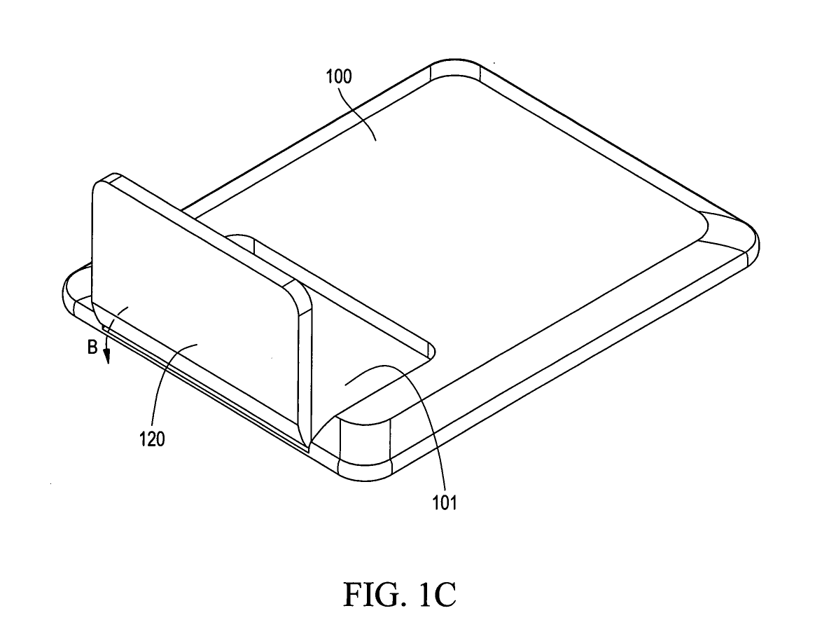

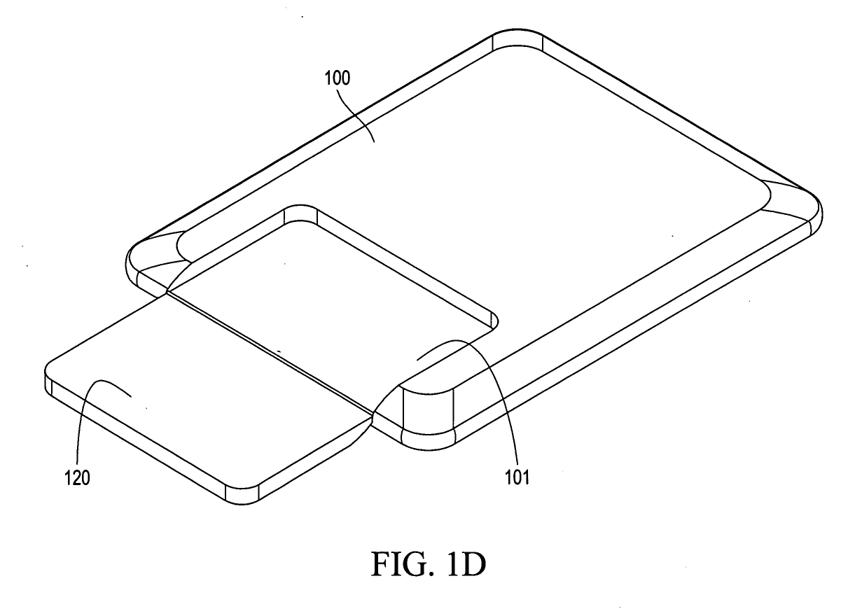

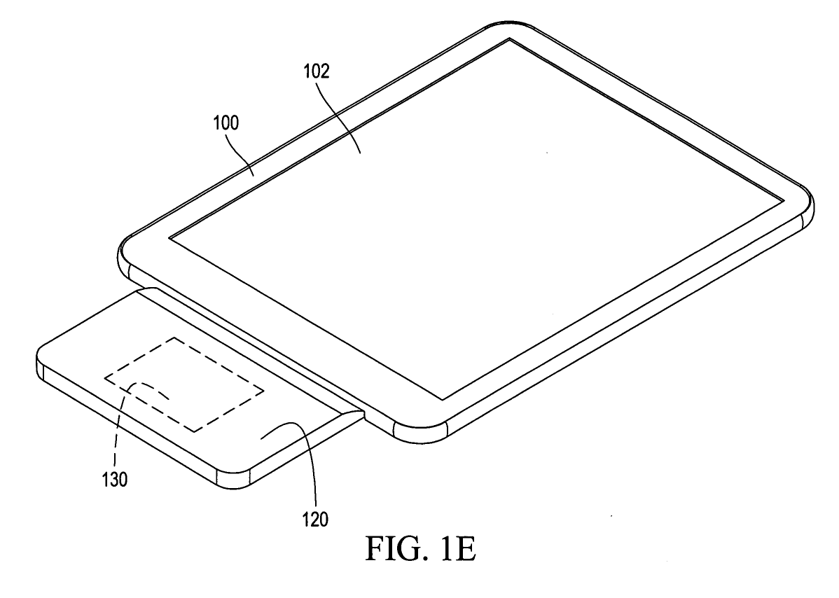

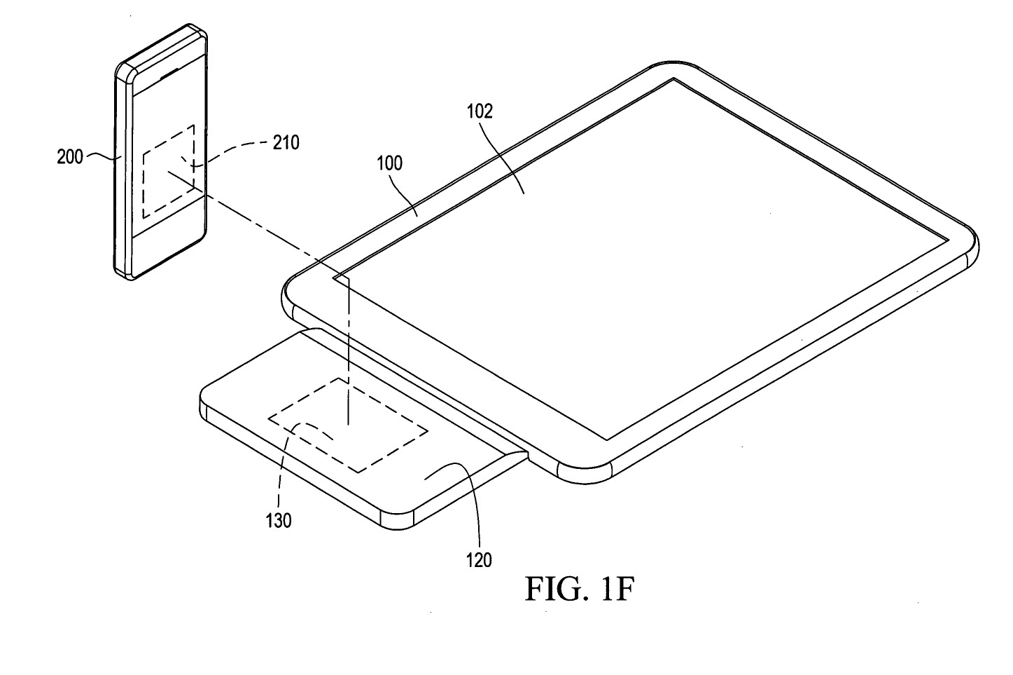

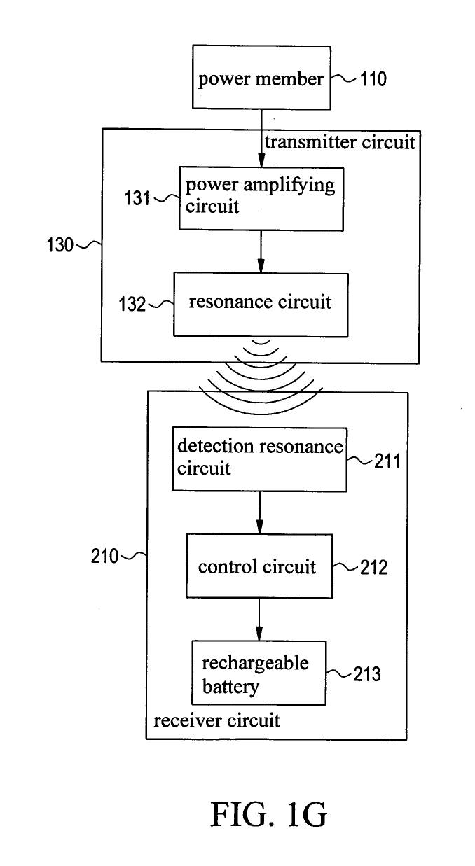

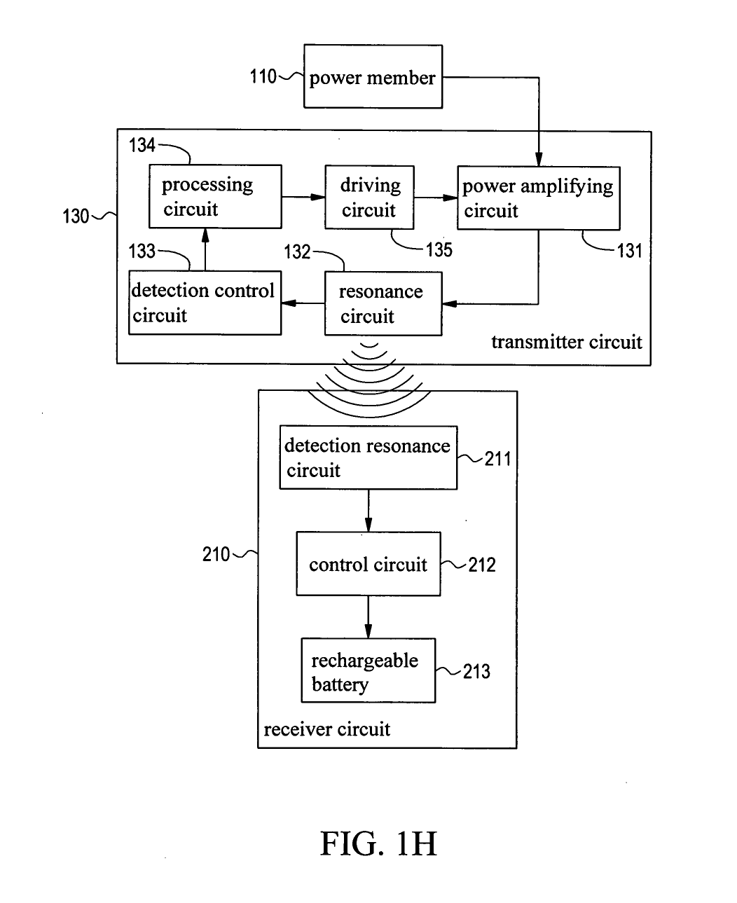

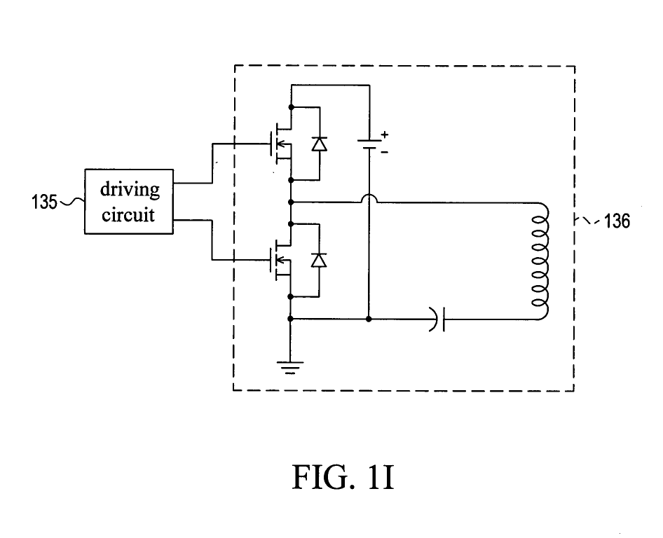

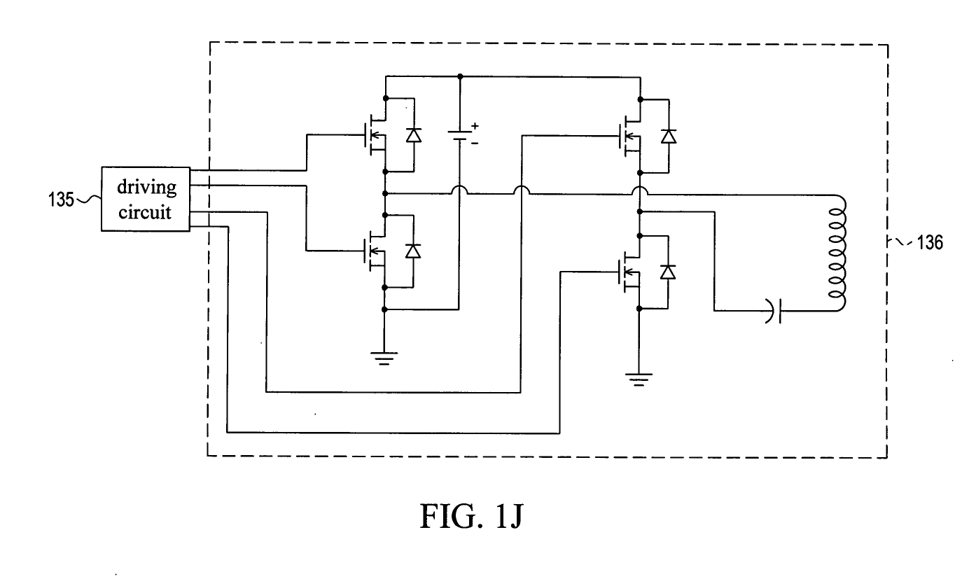

With reference to the drawings and in particular to FIGS. 1A-1J, which are respectively perspective views showing various conditions of an electronic book with wireless charging feature according to an embodiment of the present invention, a perspective view illustrating use of the electronic book according to the present invention, and circuit diagrams of the electronic book according to the present invention, the electronic book according to the present invention comprises a main body 100 and a carrier board 120. The carrier board 120 is provided with a transmitter circuit 130, whereby a user may place an electronic device 200 that comprises a receiver circuit 210 on the main body 100 for performance of a charging operation on the electronic device 200 through wireless transmission.

The main body 100 comprises a power member 110 (which can be a rechargeable battery or a power cord of the main body 100). The main body 100 comprises a receptacle 101 and a touch screen 102. The receptacle 101 is formed to receive therein the carrier board 120 that is coupled to the main body 100 in a movable manner, whereby the electronic device 200 is positionable on the carrier board 120. Further, the carrier board 120 contains therein the transmitter circuit 130, whereby the power member 110 supplies electrical power to the transmitter circuit 130 and the transmitter circuit 130 converts the electrical power into an AC (alternate current) signal. The AC signal is then transmitted by the transmitter circuit 130 to the receiver circuit 210 of the electronic device 200 through wireless transmission. The receiver circuit 210 receives and converts the AC signal into electrical power and stores and supplies the electrical power to the electronic device 200.

The transmitter circuit 130 comprises a power amplifying circuit 131 connected to the power member 110 and a resonance circuit 132 connected to the power amplifying circuit 131, whereby the power amplifying circuit 131 converts the electrical power supplied from the power member 110 into an AC signal. The AC signal is amplified by the power amplifying circuit 131 and the amplified AC signal is processed by the resonance circuit 132 to retrieve resonance energy. The AC signal is then transmitted by the resonance circuit 132 to the receiver circuit 210 (see FIG. 1G).

Further, the transmitter circuit 130 may further comprise a detection control circuit 133 connected to the resonance circuit 132, a processing circuit 134 connected to the detection control circuit 133, and a driving circuit 135 connected to the processing circuit 134 and the power amplifying circuit 131, whereby the detection control circuit 133 detects the magnitude of the AC signal transmitted by the resonance circuit 132 and the processing circuit 134, which is pre-provided with a predetermined signal, compares the predetermined signal with the AC signal to generate a frequency regulation signal based on which the driving circuit 135 regulates the signal frequency and thus the power of the power amplifying circuit 131 is regulated for feeding back and controlling the AC signal transmitted by the resonance circuit 132 and providing the AC signal with stabilized power (see FIG. 1H).

Further, the power amplifying circuit 131 and the resonance circuit 132 are both power circuits. Alternatively, the power amplifying circuit 131 and the resonance circuit 132 can be combined as a power integration circuit 136, which comprises a circuit generally composed of at least two metal-oxide-semiconductor field effect transistors (MOSFETs), whereby the power integration circuit 136 forms a half-bridge power circuit (see Figure 1I) or a full-bridge power circuit (see FIG. 1J) through electrical connection between the MOSFETs.

The electronic device 200 can be a portable electronic product, such as a multimedia player and a mobile phone. The receiver circuit 210 of the electronic device 200 comprises an detection resonance circuit 211, a control circuit 212 connected to the detection resonance circuit 211, and a rechargeable battery 213 connected to the control circuit 212, whereby the detection resonance circuit 211 detects and receives the AC signal transmitted from the transmitter circuit 130 and the control circuit 212 converts the AC signal received by the detection resonance circuit 211 into electrical power and performs voltage regulation of the electrical power so converted. The electrical power is then stored in the rechargeable battery 213, whereby the rechargeable battery 213 may subsequently supply the electrical power to the electronic device 200.

In the embodiment illustrated, the main body 100 comprises a receptacle 101, in which a carrier board 120 is received. The carrier board 120 is provided with a transmitter circuit 130. The carrier board 120 is coupled to the main body 100 through pivotal connection, whereby the carrier board 120 is rotatable with respect to the main body 100 (as indicated by the moving direction A of FIG. 1B and the moving direction B of FIG. 1C). In other words, when a user attempts to electrically charge the electronic device 200 (such as a mobile phone), the user rotate 120 away from the main body 100 to set the main body 100 and the carrier board 120 in an expanded condition which allows the electronic device 200 to be positioned on the carrier board 120, whereby electrical power that is supplied from the power member 110 to the transmitter circuit 130 is converted by the transmitter circuit 130 into an AC signal that is then transmitted by a resonance circuit 132 of the transmitter circuit 130, through wireless transmission, to a receiver circuit 210 of the electronic device 200 to electrically charge the receiver circuit 210 and thus supplying electrical power to the electronic device 200. In order words, a user may simultaneously operate a touch screen 102 of the main body 100 and perform charging to a portable electronic device, so that electrical charging can be realized without applying an additional electrical charger. The problem of limited range of using an electrical charger that requires wired connection can thus be overcome. In addition, easy collapse and expansion can be made according to the desire of a user, whereby carrying and storing are easy and the convenience of use is improved.

### Second Embodiment

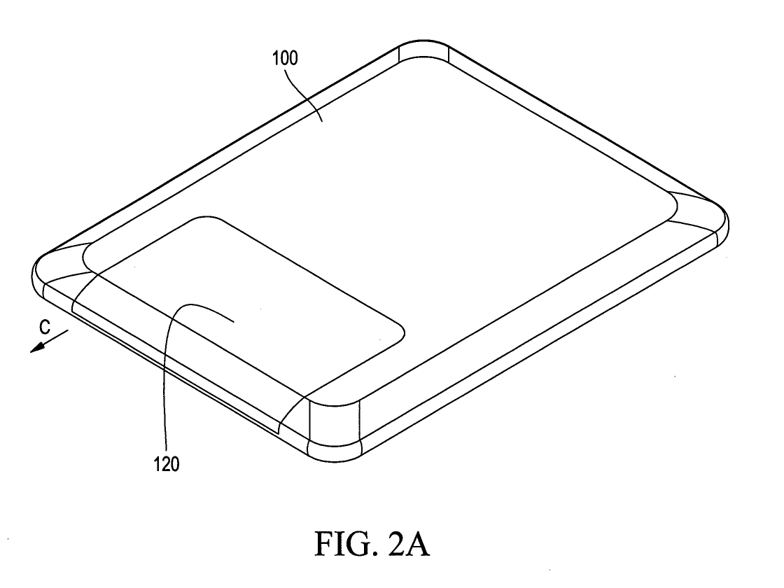

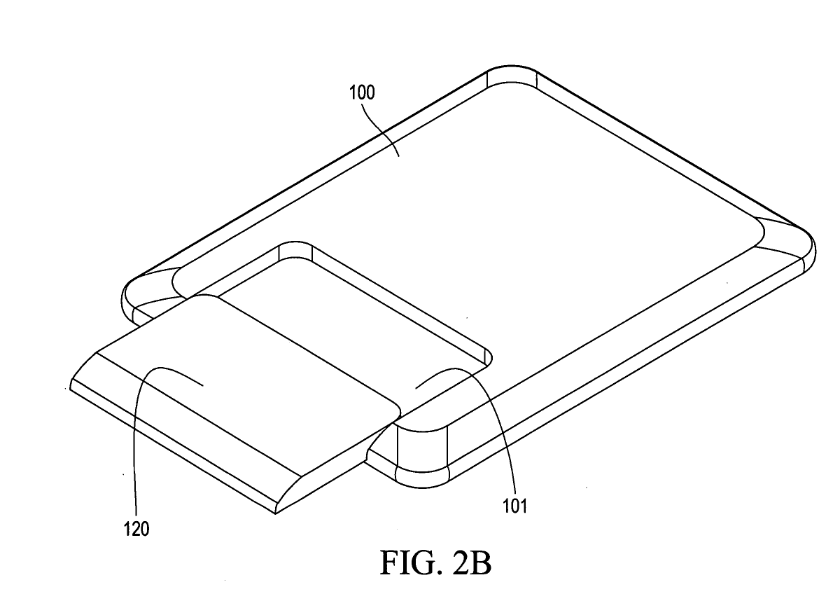

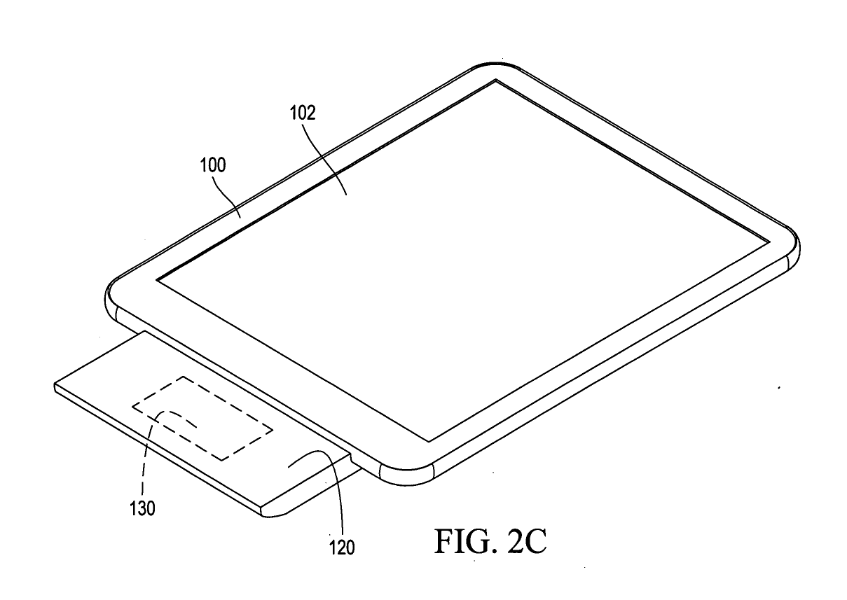

Referring to FIGS. 2A and 2C, which are perspective views showing an electronic book with wireless charging feature according to a second embodiment of the present invention, the second embodiment is substantially identical to the first embodiment with a major difference therebetween being that the carrier board 120 and the main body 100 are connected to each other in a sliding extendible manner (similar to a regular extendible cartridge), whereby the carrier board 120 can be caused by a depression operation to slide away from the main body 100 (as indicated by the moving direction C of FIG. 2A) so as to set the main body 100 and the carrier board 120 in an expanded condition, which allows an electronic device 200 to be positioned on the carrier board 120 to electrically charge the electronic device 200. The carrier board 120, when not in use, can be moved by being depressed by a user in a direction toward the main body 100 so as to stow the carrier board 120 in the receptacle 101; this makes stowing and carrying easy.

In summary, the present invention provides an electronic book with wireless charging feature generally comprises a main body 100 that is provided with a receptacle 101 in which a carrier board 120 is received and the carrier board 120 is movably coupled to the main body 100, whereby when a user attempts to electrically charge an electronic device 200 that is provided with a receiver circuit 210, the electronic device 200 is positioned on the carrier board 120 and a transmitter circuit 130 transmits, through wireless transmission, an AC signal to the receiver circuit 210 so as to electrically charge the rechargeable battery 213 of the receiver circuit 210. The electrical power can thus be stored and subsequently supplied to the electronic device 200. As such, the problem of limited range of using an electrical charger that requires wired connection can thus be overcome. In addition, easy collapse and expansion can be made according to the desire of a user, whereby carrying and storing are easy and the convenience of use is improved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electronic book, which is adapted to couple with an electronic device comprising a receiver circuit, the electronic book comprising:
a main body, which comprises a power member and forms a receptacle;
a carrier board, which is coupled to the main body and is receivable in the receptacle, the carrier board being adapted to receive the electronic device positioned thereon; and
at least one transmitter circuit, which is provided in the carrier board and receives electrical power from the power member, the transmitter circuit converting the electrical power into an alternate-current signal, which is transmitted by the transmitter circuit to the receiver circuit of the electronic device in a wireless manner to allow the receiver circuit to convert the alternate-current signal into electrical power for performing electrical charging operation.

2. The electronic book as claimed in claim 1, wherein the transmitter circuit comprises a power amplifying circuit and a resonance circuit, the power amplifying circuit being connected to the power member, the power amplifying circuit converting the electrical power transmitted from the power member into an alternate-current signal and amplifying the alternate-current signal, the resonance circuit being connected to the power amplifying circuit, the resonance circuit transmitting the alternate-current signal that is amplified by the power amplifying circuit to the receiver circuit.

3. The electronic book as claimed in claim 2, wherein the transmitter circuit further comprises a detection control circuit, a processing circuit, and a driving circuit, the detection control circuit being connected to the resonance circuit, the detection control circuit detecting magnitude of the alternate-current signal transmitted by the resonance circuit, the processing circuit being connected to the detection control circuit, the processing circuit being provided with a predetermined signal, the processing circuit comparing the predetermined signal with the alternate-current signal to generate a frequency regulation signal, the driving circuit being connected to the processing circuit and the power amplifying circuit, the driving circuit regulating signal frequency based on the frequency regulation signal and the driving circuit regulating power of the power amplifying circuit for feeding back and controlling the alternate-current signal transmitted by the resonance circuit to provide stabilized power of the alternate-current signal.

4. The electronic book as claimed in claim 2, wherein the power amplifying circuit and the resonance circuit are combined as a power integration circuit.

5. The electronic book as claimed in claim 4, wherein the power integration circuit comprises a circuit composed of at least two MOSFETs.

6. The electronic book as claimed in claim 5, wherein the power integration circuit comprises one of a half-bridge power circuit and a full-bridge power circuit.

7. The electronic book as claimed in claim 1, wherein the receiver circuit comprises a detection resonance circuit, a control circuit, and a rechargeable battery, the detection resonance circuit receiving the alternate-current signal transmitted by the transmitter circuit, the control circuit being connected to the detection resonance circuit, the control circuit converting the alternate-current signal received by the detection resonance circuit into electrical power and performing voltage regulation of the electrical power, the rechargeable battery being connected to the control circuit, the rechargeable battery storing the electrical power converted by the control circuit.
